(19) United States
(12) Patent Application Publication
(10) Pub. No.: US 2008/0159260 A1
(43) Pub. Date: Jul. 3, 2008

(54) FIBRE CHANNEL OVER ETHERNET FRAME

(75) Inventors: Suresh Vobbilisetty, San Jose, CA (US); Robert Norman Snively, Morgan Hill, CA (US); Glenn Charles Wenig, Pleasanton, CA (US); Hiren Desai, San Jose, CA (US)

Correspondence Address: HENSLEY KIM & HOLZER, LLC, 1660 LINCOLN STREET, SUITE 3000, DENVER, CO, 80264, US

(73) Assignee: Brocade Communications Systems, Inc., San Jose, CA (US)

(21) Appl. No.: 11/958,319

(22) Filed: Dec. 17, 2007

Related U.S. Application Data
(60) Provisional application No. 60/870,157, filed on Dec. 15, 2006.
(60) Provisional application No. 60/914,313, filed on Apr. 26, 2007.
(60) Provisional application No. 60/914,847, filed on Apr. 30, 2007.

(51) Int. Cl. H04L 12/28

(52) U.S. Cl. 370/351

(57) ABSTRACT

A Fibre Channel over Ethernet (“FCoE”) frame format allows a Fibre Channel (“FC”) base frame to be transmitted and routed through an Ethernet network. In one implementation, an FCoE frame includes SCSI information represented in a FC frame to which is prepended an FCoE header. The FCoE header/FC frame combination is encapsulated in an Ethernet frame shell to form an FCoE frame. Implementations of the FCoE frame may include an FCoE header containing fields and data pertaining to the version of the FCoE header of the FCoE frame, synchronized time values, various flags, directional values, and type values.

### CROSS-REFERENCE TO RELATED APPLICATIONS

The present application claims benefit of U.S. Provisional Patent Application No. 60/870,157, filed Dec. 15, 2006 and entitled “Fibre Channel over Ethernet”; U.S. Provisional Patent Application No. 60/914,313, filed Apr. 26, 2007 and entitled “Fibre Channel over Ethernet”; U.S. Provisional Patent Application No. 60/914,847, filed Apr. 30, 2007 and entitled “Fibre Channel over Ethernet”, all of which are specifically incorporated by reference for all that they disclose and teach.

### BACKGROUND

A storage area network (SAN) may be implemented as a high-speed, special purpose network that interconnects different kinds of data storage devices with associated data servers on behalf of a large network of users. Typically, a storage area network includes high performance switches as part of the overall network of computing resources for an enterprise. The storage area network is usually clustered in close geographical proximity to other computing resources, such as mainframe computers, but may also extend to remote locations for backup and archival storage using wide area network carrier technologies. Fibre Channel networking is typically used in SANs although other communications technologies may also be employed, including Ethernet and IP-based storage networking standards (e.g., iSCSI, FCIP (Fibre Channel over IP), etc.).

As used herein, the term “Fibre Channel” refers to the Fibre Channel family of standards (developed by the American National Standards Institute (ANSI)) and other related and draft standards. In general, Fibre Channel defines a transmission medium based on a high speed communications interface for the transfer of large amounts of data via connections between varieties of hardware devices.

In a typical SAN, one or more Fibre Channel switches are used to communicatively connect one or more server devices with one or more data storage devices. Such switches generally support a high performance switching fabric and provide a number of communication ports for connecting to other switches, servers, storage devices, or other SAN devices. Other high performance fabrics may employ different fabric technologies, such as Infiniband.

Other networking technologies, such as Ethernet, may also be employed in communicating between computing and networking devices. However, these networking technologies do not work seamlessly with high performance networks, such as a Fibre Channel network. For example, the frame formats between Ethernet and Fibre Channel are sufficiently different to preclude transmitting a Fibre Channel frame through an Ethernet network without modification.

### SUMMARY

Implementations described and claimed herein address the foregoing problems by providing a Fibre Channel over Ethernet (“FCoE”) frame that allows a Fibre Channel (“FC”) base frame to be transmitted and routed through an Ethernet network. In one implementation, an FCoE frame includes SCSI information represented in a FC frame to which is prepended an FCoE header. The FCoE header/FC frame combination is encapsulated in an Ethernet frame shell to form an FCoE frame. Implementations of the FCoE frame may include an FCoE header containing fields and data pertaining to the version of the FCoE header of the FCoE frame, synchronized time values, various flags, directional values, and type values.

Other implementations are also described and recited herein.

### BRIEF DESCRIPTIONS OF THE DRAWINGS

FIG. 1 illustrates an exemplary computing and storage framework including a local area network (LAN) and a storage area network (SAN).

FIG. 2 illustrates example communications stacks and an example FCoE frame format progression through an FCoE communications stack.

FIG. 3 illustrates an example FCoE frame format.

FIG. 4 illustrates another example FCoE frame format.

FIG. 5 illustrates yet another example FCoE frame format.

FIG. 6 illustrates example operations for transmitting an FCoE frame down through a communications stack.

FIG. 7 illustrates example operations for receiving an FCoE frame up through a communications stack.

### DETAILED DESCRIPTIONS

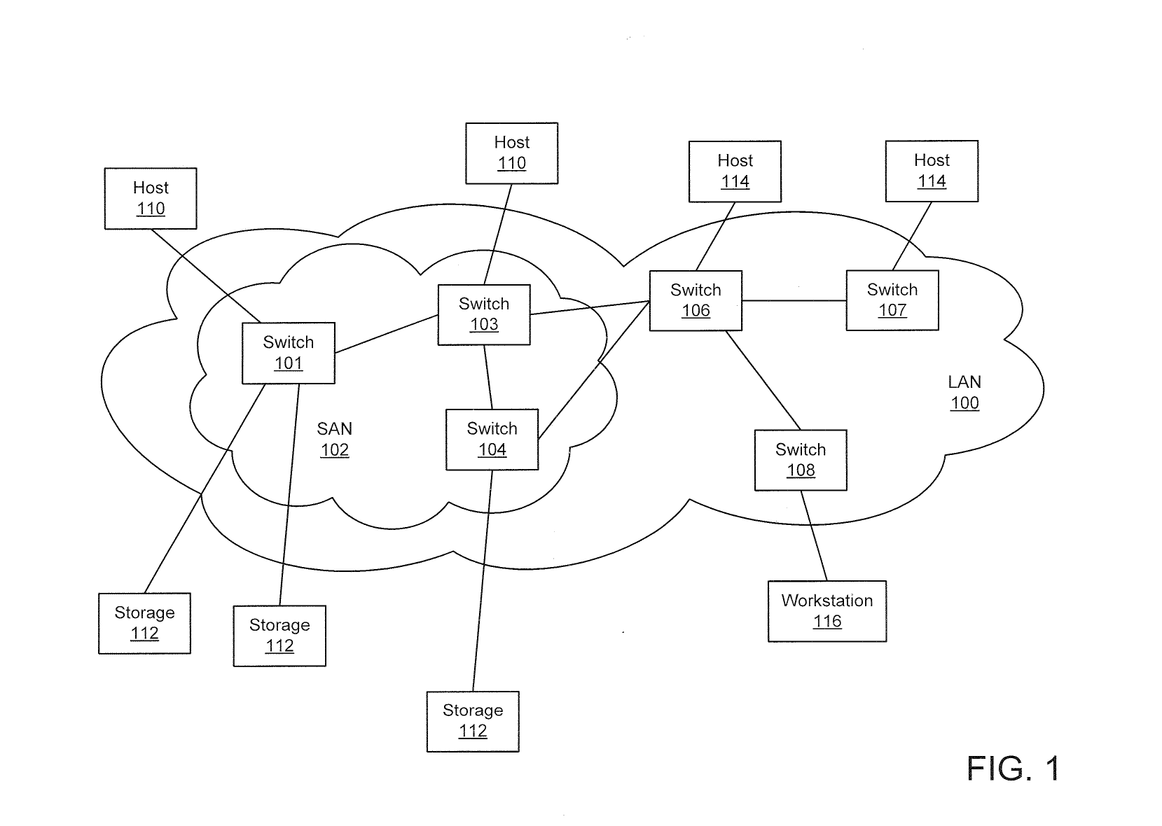

FIG. 1 illustrates an exemplary computing and storage framework including a local area network (LAN) 100 and a storage area network (SAN) 102. FIG. 1 illustrates an exemplary computing and storage framework including a local area network (LAN) 100 and a storage area network (SAN) 102. A local area network (LAN) 100 provides communication connectivity among multiple devices, such as a workstation 116 and hosts 114. Connectivity within the LAN 100 is provided by switches 106, 107 and 108. The LAN 100 is presumed to be the network for a relevant enterprise with a number of different segments, although any LAN configuration may be employed.

A storage area network (SAN) 102 resides within the LAN 100 and provides communication connectivity, routing, and other SAN functionality among hosts 110 and storage units 112. The SAN 102 includes a number of switches, such as switches 101, 103 and 104. Switches 101, 103 and 104, for example, may be configured as a set of blade components inserted into a chassis, as rackable or stackable modules, or as other device structures. In one implementation, the chassis has a back plane or mid-plane into which the various blade components, such as switching blades and control processor blades, may be inserted.

Two of the switches, i.e., switches 103 and 104, of the SAN 102 are connected within the LAN 102 via a switch 106. The switch 106 is also used to join other segments of the LAN 100, as represented by the other switches 107 and 108, which are also shown in the LAN 100. In addition, a series of hosts 110 are connected to various switches 104 in the SAN 102. Likewise storage units, such as described storage units 112, are connected also to various switches 104 in the SAN 102.

Various application clients, such as the workstation 116, are networked to application servers, such as the hosts 114, via the LAN 100. A user can access applications resident on the hosts 114 through the workstation 116. The applications may depend on data (e.g., an email database) stored at one or more of the storage units 112. Accordingly, in the illustrated example, the SAN 102 provides connectivity among the hosts 114, the workstation 116, and the application data storage devices 112 to allow the applications to access the data they need to operate.

The hosts 114 and switches 103 and 104 are configured to communicate using one of a variety of frame formats, so as to allow a Fibre Channel frame to be transported over an Ethernet network, such as LAN 100. Variations of these frame formats are provided in the described implementations.

The host, storage device, and switch ports in the FCoE network may be designated as FCoE N_PORTs, FCoE F_PORTs, FCoE E_PORTs, and variations thereof. For example, a port of an FCoE storage device connected to the FCoE network may be designated an FCoE N_PORT, a port of an FCoE/Ethernet switch connected to a port of an FCoE storage device or host may be designated an FCoE F_PORT, and a port of an FCoE switch connected to a port of another FCoE switch in the FCoE network may be designated as an FCoE E_PORT.

Generally, a developing standard called Fibre Channel over Ethernet (FCoE) allows Fibre Channel (FC) frames to be transmitted and received over an Ethernet network. In one implementation, a standard FC frame is equipped with a specified FCoE header and encapsulated within an Ethernet frame for communication through the Ethernet network. When an FCoE frame is transmitted through the Ethernet network and reaches a properly equipped FC switch at the boundary of a SAN, the FC switch strips off the Ethernet and FCoE portions of the frame and forwards the embedded FC frame through the SAN. Likewise, when a standard FC frame is transmitted through the SAN and reaches a properly equipped FC switch at the boundary of the SAN and an Ethernet network, the FC switch adds an FCoE header and an Ethernet header (with appropriate synchronization fields) to the FC frame and forwards the newly-enhanced FCoE frame to the Ethernet network.

The Ethernet header of the FCoE frame includes source and destination L2 addresses, such as MAC addresses, which the Ethernet network uses to communicate the frame to its intended destination. For example, hosts and other devices on the Ethernet network can receive the FCoE frame if they are configured to receive frames having the MAC address in the destination field of the Ethernet header. Typically, each host or other device maintains a list of MAC addresses it is configured to receive. Such MAC addresses may be uni-cast addresses, multi-cast addresses, virtual addresses, etc.

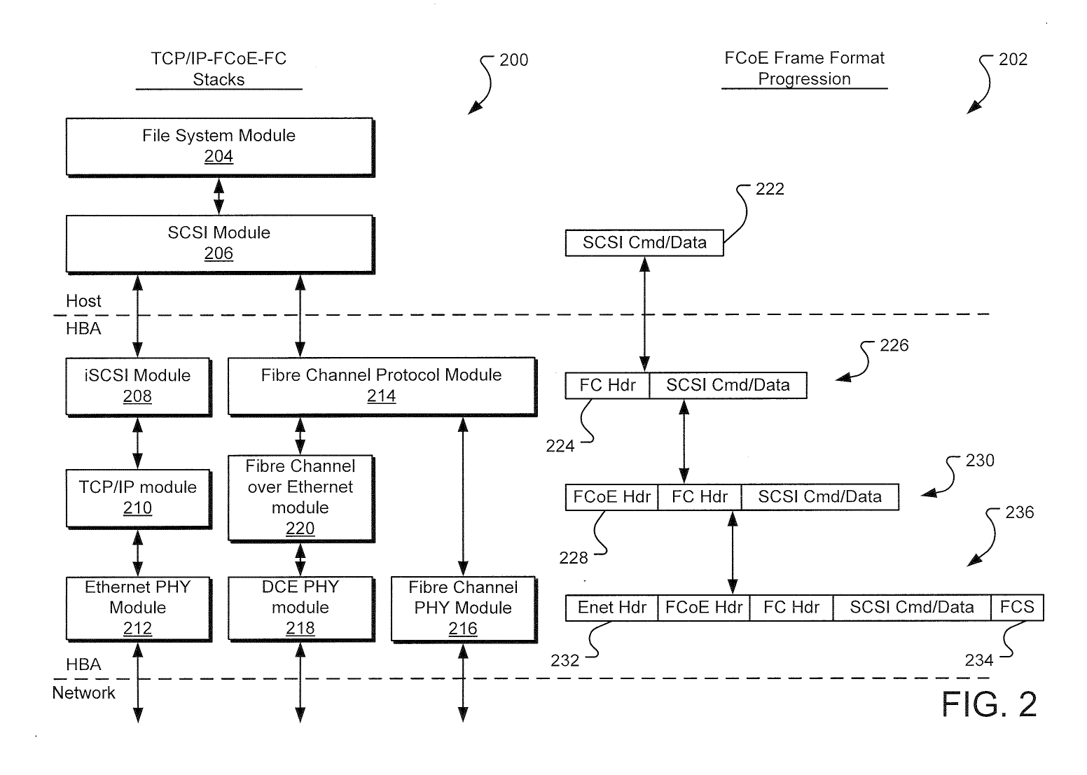

FIG. 2 illustrates example communications stacks 200 and an example FCoE frame format progression 202 through an FCoE communications stack. Aspects of the communications stacks 200 are categorized relative to the network, the host bus adapter (“HBA”) and the host. It should also be understood that communications stacks for a storage device or other peripheral may be similarly configured. Furthermore, the network generally refers to one or more communications networks and may include one or more types of networks (e.g., Ethernet, Fibre Channel) or combinations thereof.

Generally, communication stacks are implemented in software, hardware, or a combination of both. In one implementation, the FCoE communications stack is implemented in software that interacts with the hardware of the host, HBA, and the physical network. The lowest level of the stack interacts with the physical interface to the network and the highest level of the stack interacts with aspects of the operating system, file system and/or applications. The software may be implemented in firmware that interacts with the hardware resources of a host, a switch, a data storage device, etc.

A file system module 204 is maintained by the host. Generally, a file system includes a set of abstract data types and procedures for the storage, hierarchical organization, manipulation, access, and retrieval of data. The file system module 204 includes code and data structures for implementing a file system on the host.

A Small Computer System Interface (SCSI) module 206 is coupled to access data maintained by the file system module 204. Generally, SCSI refers to a set of standards for physically connecting and transferring data between computers and peripheral devices, such as storage devices. The SCSI standards define commands, protocols, and electrical and optical interfaces. SCSI is most commonly used for hard disks and tape drives, but it can connect a wide range of other devices, including scanners, and optical discs (CDs, DVDs, etc.). The SCSI module 206 includes code and data structures for implementing the SCSI set of standards to connect the file system module 204 with devices on the network.

The illustration of FIG. 2 depicts multiple channels for accessing the file system module 204 through the SCSI module 206. One such channel involves an iSCSI/Ethernet communications stack, including an iSCSI module 208, a TCP/IP module 210, and an Ethernet PHY module 212. Generally, iSCSI refers to a defined protocol that allows clients (called “initiators”) to send SCSI commands to SCSI storage devices (“targets”) on remote servers. iSCSI allows organizations to consolidate storage into data center storage arrays while providing hosts (such as database and web servers) with the illusion of locally-attached disks. iSCSI can be run over long distances using existing network infrastructure, such as an Ethernet network. The iSCSI module 208 includes code and data structures for implementing the iSCSI protocol in the HBA.

The TCP/IP module 210 implements layers of a set of communication protocols that contribute to the transmission and receipt of data via a communication network. The Internet Protocol (IP) layer manages exchange of data frames over the network. Data frames are short sequences of data bytes, typically consisting of a header and a body. The header describes the frame's destination and the routers in the network used to pass the data frame from the communication source. The body contains the application data, which may relate to other protocol layers. In the case of congestion, the IP protocol may discard frames. Also, two ordered frames may take different routes through the network and therefore arrive at the HBA in the wrong order. The Transmission Control Protocol (TCP) layer provides for relatively reliable, in-order delivery of a stream of bytes transferred over a network. The TCP layer provides a simple interface to upper layers (e.g., the iSCSI module 208) by hiding most of the underlying frame structures, rearranging out-of-order frames, minimizing network congestion, and re-transmitting discarded frames. The TCP/IP module 210 includes code and data structures for implementing the TCP and IP layers in the HBA.

The Ethernet PHY module 212 includes code and data structures for implementing a communications via a frame-based computer networking technology for local area and wide area networks. Generally, Ethernet is standardized as IEEE 802.3, which defines a number of wiring and signaling standards for the physical layer of the communications stack, particularly through means of network access at the Media Access Control (MAC) and Data Link Layer, and a common addressing format. Wireless Ethernet is also standardized as IEEE 802.11 and its variations. The Ethernet PHY module 212 provides the physical layer interface between the HBA and the network.

In combination, the Ethernet, TCP/IP, and iSCSI communications stack provides block storage over Ethernet using a unique protocol to carry SCSI commands and a relatively expensive TCP/IP transport.

An alternative communications stack includes a Fibre Channel Protocol (FCP) module 214 and a Fibre Channel PHY (Physical Layer) module 216. Generally, FCP defines an interface protocol of SCSI on Fibre Channel networks, which are typically used as storage area networks. The FCP module 214 includes the code and data structures for dividing SCSI information, including command transfers, data transfers, response transfers, and some additional transfer types, into FCP information units. The FCP information units are mapped into Fibre Channel Sequences (e.g., one information unit per Fibre Channel Sequence) using FC frames. An FC header of an FC frame contains description information pertaining to the information unit that is used to implement the FCP. In this manner, the FCP module 214 implements the interface between the SCSI module 206 and the physical network connection to the network implemented by the Fibre Channel PHY module 216.

Yet a third communications stack, which supports FCoE, combines aspects of the Ethernet-TCP/IP-iSCSI communications stack with the Fibre Channel communications stack. A goal of FCoE is to provide I/O consolidation over Ethernet to assist in reducing network complexity in the data centers. Generally, FCoE replaces the physical layer of the standard Fibre Channel stack with an Ethernet physical layer, thereby allowing a seamless integration in existing Fibre Channel networks and management software. An FCoE HBA appears as a Fibre Channel Card to a host and as an Ethernet adapter to a DCE network.

A Data Center Ethernet (“DCE”) PHY module 218 (a type of “Ethernet PHY module”) provides a lossless variation of Ethernet communications over an Ethernet network. Generally, DCE defines physical layer technology for consolidating LAN communications, SAN communications, and interprocess communications (“IPC”) over an Ethernet network. The DCE module 214 includes the code and data structures for implementing this interface between the HBA and the DCE network. A Fibre Channel of Ethernet (“FCoE”) module 220 and Fibre Channel Protocol module 214 provides code and data structures for interfacing between the DCE PHY module 218 and the SCSI module 206.

The frame format progression 202 depicted beside the communications stacks 200 maps the portions of an FCoE frame contributed by different layers and/or modules of the FCoE communications stack, which includes the SCSI module 206, the FCP module 214, the FCoE module 220 and the DCE PHY module 218. An FCoE frame may be communicated in either direction up or down the FCoE communications stack. When traveling up the stack from the network to the SCSI module 206, portions of the frame are stripped off and used by the corresponding layer. The remaining frame portion is then communicated up the stack to the next layer for processing. In contrast, when traveling down the stack from the SCSI module 206 to the network, the frame is supplemented by concatenating additional frame portions onto the front and/or back of the frame.

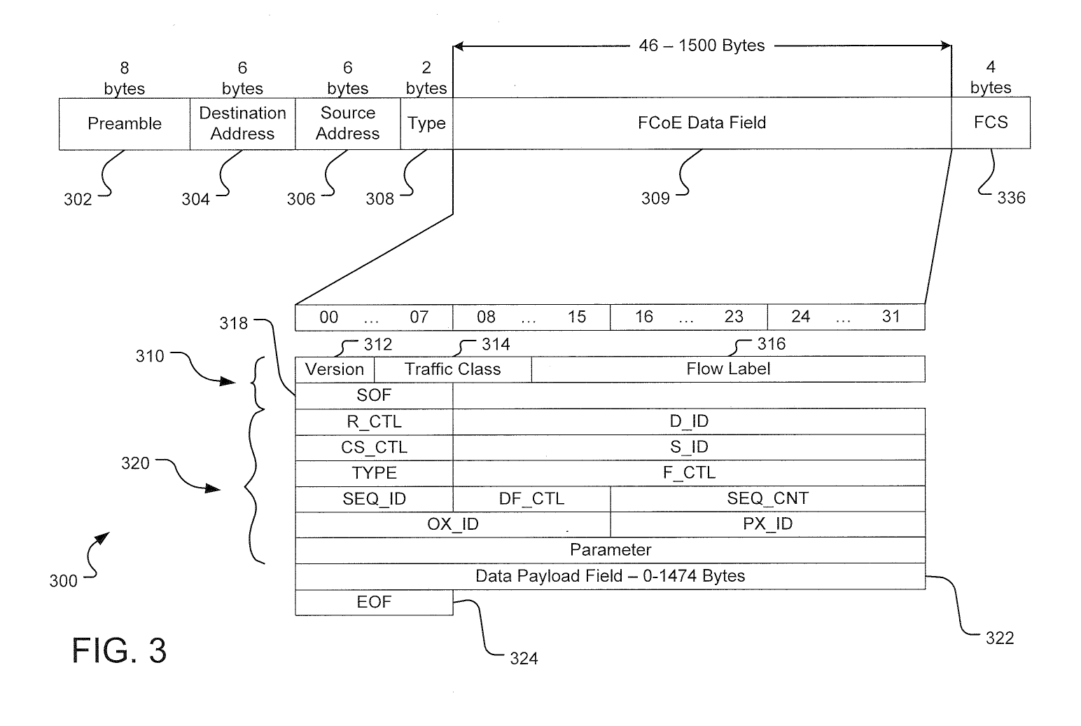

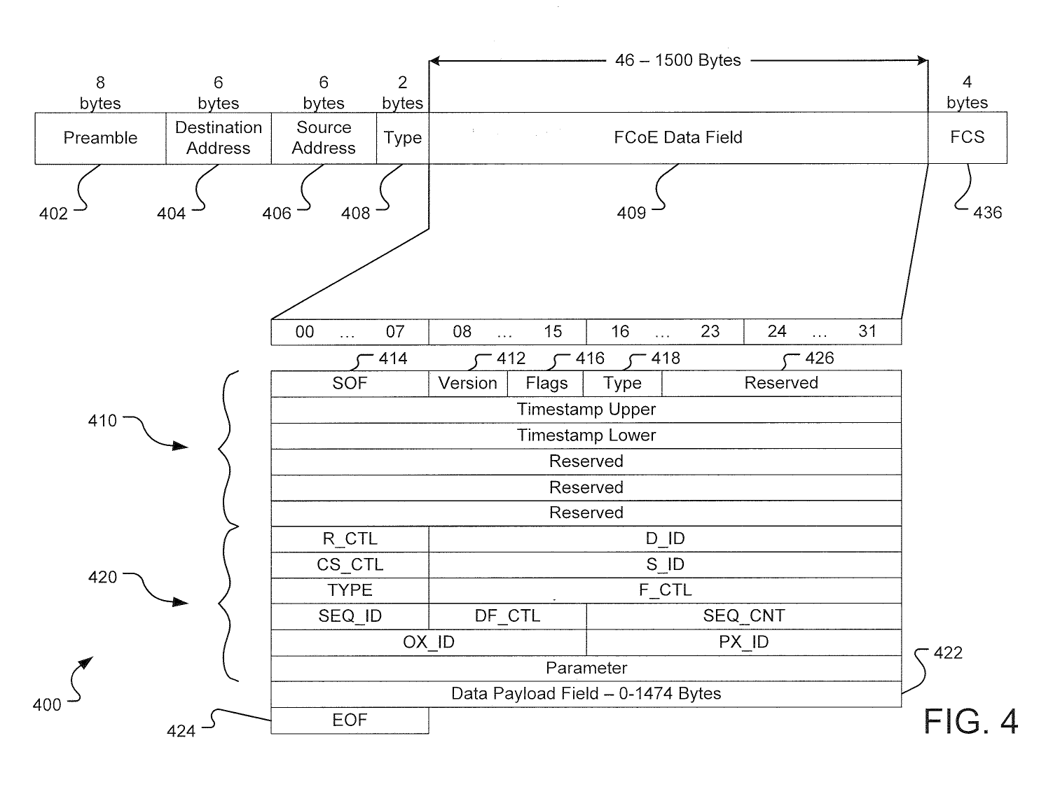

For example, the SCSI module 206 generates SCSI Cmd/Data information 222 and passes it down the communications stack to the FCP module 214. The FCP module 214 divides the SCSI Cmd/Data information 222 into FCP information units, which are mapped into Fibre Channel Sequences using FC frames. Each FC frame, such as FC frame 226, includes an FC header 224. As described with regard to FIGS. 3-4, the FC header 224 provides data to support standard FCP compliance. The FCP module 214 then passes each FC frame 226 down the communications stack to the FCoE module 220.

The FCoE module 220 adds the FCoE header 228 to the FC frame 226 to form an intermediate frame 230. As described with regard to FIGS. 3-4, the FCoE header 224 provides data to allow the FC frame 226 to be communicated through an Ethernet network when encapsulated within an Ethernet frame. The FCoE module 220 then passes the intermediate frame 230 down the communications stack to the DCE PHY module 218.

The DCE PHY module 218 adds the Ethernet header 232 and a frame checksum (“FCS”) 234 to the intermediate frame 230 to form an FCoE frame 236. As described with regard to FIGS. 3-4, the Ethernet header 232 provides data for transmission through the Ethernet network. The FCS 234 is used for error detection and correction. Generally, the DCE PHY module 218 computes a checksum on the entire frame and appends the checksum to the end of the frame. The device receiving the frame 236 computes the checksum on the frame using the same algorithm and compares it to the received FCS 234. In this manner, the receiving device can detect whether any data was lost or altered in transit. If an error is detected, the receiving device may attempt to correct the error or otherwise discard the data and request retransmission of the faulty frame. A cyclic redundancy check is often used to compute the FCS 234. After constructing the frame 236, the DCE PHY module 218 transmits the frame 236 into the communications network.

When receiving an FCoE frame 236 from the network, the DCE PHY module 218 strips the Ethernet header 232 and FCS 234 from the FCoE frame 236 to expose the intermediate frame 230, which it passes up the communications stack to the FCoE module 220. The FCoE module 220 strips off the FCoE header 228 from the intermediate frame 230 to expose the FC frame 226 and passes it up the communications stack to the FCP module 214. The FCP module 214 strips off the FC header 224 from the FC frame 226. One or more FC frames may contribute to generate the SCSI Cmd/Data information 222, which the SCSI module 206 uses to access the file system 204.

FIG. 3 illustrates an example FCoE frame format 300 as an ordered sequence of data fields grouped into a discrete frame structure, including an Ethernet preamble field 302. In one implementation, the Ethernet preamble field 302 is specified to include 7 bytes forming an alternating pattern of one bits and zero bits that indicate to a receiving device that a frame is arriving from the network. The receiving device then attempts to synchronize the frame-reception portion of the DCE module with the incoming bit stream in the preamble. The Ethernet preamble field 302 is also specified to include a 1-byte start-of-frame (SOF) delimiter, which includes an alternating pattern of one bits and zero bits, which ends in two consecutive one bits. These last two bits indicate to the receiving device that the next bit to be received is the left-most bit of the left-most byte of the destination address of the incoming frame. It should be understood that other Ethernet preambles are also contemplated and may depend on the speed and transmission medium.

A destination address field 304 is specified to store a 6-byte Ethernet MAC address of the intended recipient device. A MAC address is a form of layer-2 (“L2”) address in communication architectures. A source address field 306 is specified to store a 6-byte Ethernet MAC address of the transmitting device. A 2-byte type field 308 is specified to store either the number of MAC-client data bytes that are contained in the FCoE data field 309 of the frame, or the frame type ID if the frame is assembled using an optional format. If the type field value is less than or equal to 1500, the number of bytes in the FCoE data field 309 is equal to the type field value. If the type field value is greater than 1536, the frame is of an optional type, and the type field value identifies the particular type of frame being transmitted or received. In one implementation, the type field 308 includes a type field value of 0xFC0E, although other values may be employed to identify an FCoE frame type.

The FCoE data field 309 is specified to store the payload of the FCoE frame, including an FCoE header 310 and a Fibre Channel frame representing SCSI information. A 4-byte FCS field 336 is specified to store the frame checksum value. In one perspective, the fields 302, 304, 306, 308, and 336 constitute an Ethernet frame shell that encapsulates the FCoE payload represented by the FCoE data field 309.

The first word of the FCoE header 310 in this implementation includes the first word of an IPv6 header. That is, the first word of the FCoE header includes a version field 312, a traffic class field 314, and a flow level field 316, as used in IPv6 operation. The 4-bit version field 312 is specified to store a version value identifying the version of the IP protocol to which the packet conforms (e.g., ‘6’). The 8-bit traffic class field 314 is specified for use by originating nodes and/or forwarding routers to identify and distinguish between different classes or priorities of IPv6 frames. The 20-bit flow level field 316 is specified for use by a source to label sequences of frames for which it requests special handling by the IPv6 routers, such as non-default quality of service.

After the first word of the FCoE header, a start-of-frame (SOF) field 318 is specified to store an SOF value from the Fibre Channel protocol. In one implementation, the SOF value is encoded according to FC-BB-3.

The next 6 words of the FCoE data field 309 represent a traditional Fibre Channel header field 320 specified by FC-FS-2 and FCP-3. A data payload field 322 follows the FC header field 320 and, in one implementation, the data payload field 322 is limited to 1474 bytes. In an alternative implementation in which jumbo Ethernet frames are supported, the data payload field 322 may be larger than 1474 bytes. Following the data payload field 322, an end of frame (EOF) field 324 is specified to store a standard FCP end of frame byte.

The use of Ethernet addressing allows use of Ethernet layer-2 switches, if desired. Inclusion of portions of an IP header may also allow further layer-3 handling of IP frames. Thus, any port that handles IP traffic, such as TCP/IP or UDP/IP, will also be able to handle FCoE frames without change. Furthermore, the inclusion of the IP portion in the FCoE frame allows for advanced host channel adapter cards that can perform TCP/IP operations, iWARP, and iSCSI operations, if desired, but can also readily handle FCoE operations.

In one implementation, the Ethernet or MAC address of the source and destination devices are unique within a SAN and within a sub-LAN. In addition, the world wide names of the Fibre Channel switch and the ports assigned to the various hosts and storage units are assigned in accordance with Network Address Authority (NAA) 1 or 2 and are based on the 48-bit MAC address of the corresponding Ethernet port. The DID and SID contained in the FC packet embedded in the FCoE data field 309 are also unique within the SAN. However, other implementations may vary from this configuration.

FIG. 4 illustrates another example FCoE frame format as an ordered sequence of data fields grouped into a discrete frame structure. An Ethernet preamble field 402, destination address field 404, source address field 406, type field 408 and FCS field 436 are equivalent to those described with regard to FIG. 3. The FCoE data field 409 is specified to store the payload of the FCoE frame, including an FCoE header 410 and a Fibre Channel frame representing SCSI information. In one perspective, the fields 402, 404, 406, 408, and 436 constitute an Ethernet frame shell that encapsulates the FCoE payload represented by the FCoE data field 409.

The first byte of the FCoE header represents a start-of-frame (SOF) field 414, which is specified to store an SOF value from the Fibre Channel protocol. In one implementation, the SOF value is encoded according to FC-BB-3.

The following 4 bits represent a 4-bit version field 412, which is specified to store a version value identifying the version of the FCoE header or FCoE protocol to which the packet conforms. A 4-bit flags field 416 is specified to include flag values, such as a flag that indicates whether the time stamps which follow the flags field 416 are valid (i.e., a “Time Stamp Valid” flag). A 4-bit type field 418 allows specification of certain FCoE frame types, such as 0x1—FCoE Echo Request Frame, 0x2—FCoE Echo Response Frame, 0x3—FCoE ARP Request Frame, and 0x4—FCoE ARP Response Frame. FIG. 4 also shows a 3-word reserved field 426.

The next two words represent timestamp fields 430 and 432, which specify a synchronized time value, such as defined in Simple Network Time Protocol (SNTP) Version 4 format for use in computing network transit times. The FCoE frame transmitting device uses suitable internal clocks and a timing service to establish and maintain the synchronized time value. One example timing service is provided by Fibre Channel time services. Another example timing service is provided by IP network SNTP servers. Other timing services may also be used.

Each FC payload (e.g., stored in the data payload field 422) that is delivered in an FCoE payload 409 shall contain a timestamp value (although certain frame types, such as FCoE payloads containing Class F frames may not include a timestamp value). If no timestamp value is specified for a Class 2 or 3 FCoE FC payload, the FCoE FC payload may not be transferred through a receiving FCoE switch. As such, such a payload would not be delivered through a receiving FCoE switch to a Fibre Channel fabric. An FCoE switch that receives a Class 2 or 3 FCoE FC payload without a timestamp value discards the FCoE FC payload. FCoE FC payloads containing Class F frames may be transmitted and received without a timestamp value. Frames of all classes received with a timestamp value that indicates that the frame having an age that exceeds the Fibre Channel timeout value of R_A_TOV will be discarded if received by an FCoE switch.

The next 6 words of the FCoE data field 409 represent a traditional Fibre Channel header field 420 specified by FC-FS-2 and FCP-3. A data payload field 422 follows the FC header field 420 and, in one implementation, the data payload field 422 is limited to 1474 bytes. In an alternative implementation in which jumbo Ethernet frames are supported, the data payload field 422 may be larger than 1474 bytes. Following the data payload field 422, an end of frame (EOF) field 424 is specified to store a standard FCP end of frame byte.

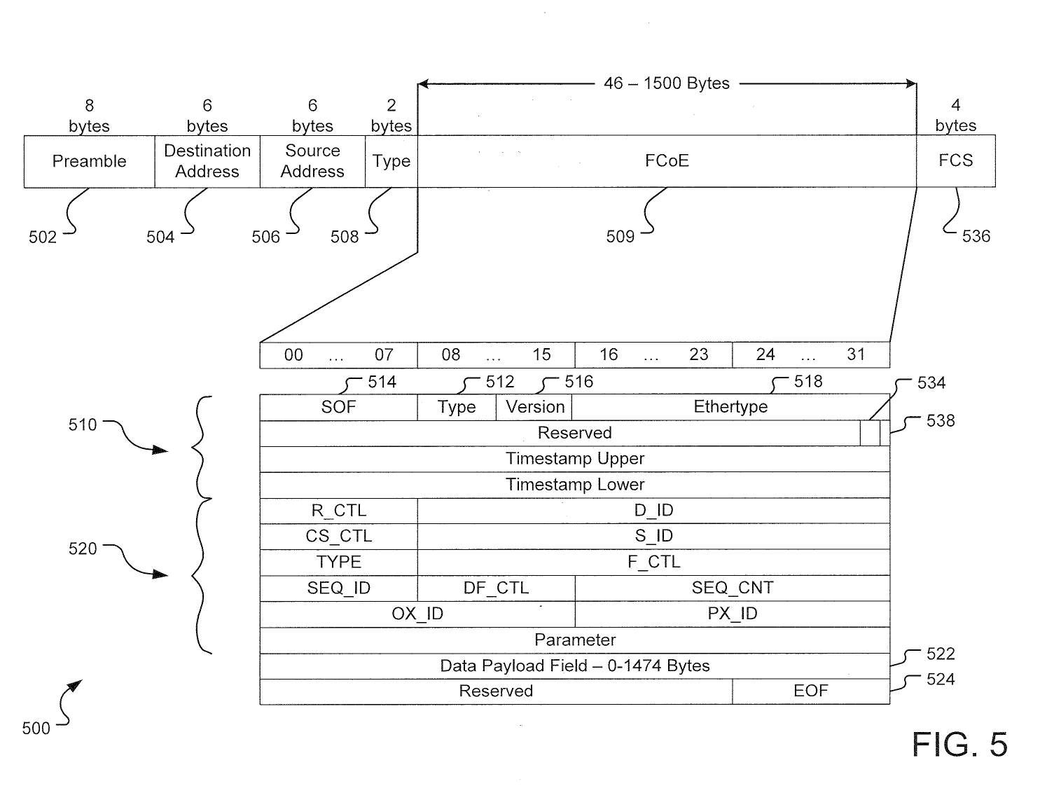

FIG. 5 illustrates yet another example FCoE frame format as an ordered sequence of data fields grouped into a discrete frame structure. An Ethernet preamble field 502, destination address field 504, source address field 506, type field 508 and FCS field 536 are equivalent to those described with regard to FIG. 3. The FCoE data field 509 is specified to store the payload of the FCoE frame, including an FCoE header 510 and a Fibre Channel frame representing SCSI information. In one perspective, the fields 502, 504, 506, 508, and 536 constitute an Ethernet frame shell that encapsulates the FCoE payload represented by the FCoE data field 509.

The first byte of the FCoE header represents a start-of-frame (SOF) field 514, which is specified to store an SOF value from the Fibre Channel protocol. In one implementation, the SOF value is encoded according to FC-BB-3. The following 4 bits represent a type field 512 that is specified to identify the type of the frame encapsulated in the overall frame. The next 4 bits represent a version field 516, which is specified to store a version value identifying the version of the FCoE header or FCoE protocol to which the packet conforms. The remainder of the word represents a 16-bit Ethertype field 518, which specifies the type of upper layer protocol in the Ethernet frame. In one implementation, the Ethertype is a registered 16-bit value provided by the IEEE registration authority. In the case of FCoE. the Ethertype value may designate Fibre Channel, such as by using the “8906” hexadecimal value, although other values may be employed.

Most of the next word is reserved. However, a 2-bit directional field 534 is specified to indicate the intended direction of the traffic:

0x00—To an FCoE E_PORT

0x01—To an FCoE N_PORT

0x02—To an FCoE F_PORT

0x03—To be determined

For example, if the frame is transmitted from an FCoE N_PORT to an FCoE F_PORT, then the directional field would store the value 0x02. The directional field 534 allows FCoE switches to identify frames that are being communicated in unintended loops within the network. If the frame is received by a port not indicated by the value in the directional field 534, the switch can drop the frame.

A 1-bit timestamp valid field 538 is specified to indicate whether the time stamps which follow the timestamp valid field 538 are valid. If valid, the two timestamp fields 530 and 532, each of one word in length, specify a synchronized time value as discussed with regard to FIG. 4.

The next 6 words of the FCoE data field 509 represent a traditional Fibre Channel header field 520 specified by FC-FS-2 and FCP-3. A data payload field 522 follows the FC header field 520 and, in one implementation, the data payload field 522 is limited to 1474 bytes. In an alternative implementation in which jumbo Ethernet frames are supported, the data payload field 522 may be larger than 1474 bytes. Following the data payload field 522, an end of frame (EOF) field 524 is specified to store a standard FCP end of frame byte, with the remainder of the last word being reserved for future use.

Although not illustrated in FIGS. 3, 4, and 5, the FCoE frame format may include an 8-bit TTL (time-to-live) field that is specified to store a TTL value governing how long the frame may propagate through the network. The units of the TTL value are seconds, indicating a time-based value. However, because each network device (e.g., a router or switch) that transfers the frame reduces the TTL value by at least one second, the TTL may degenerate to a hop count. If the TTL is decremented to zero or below, the frame is no longer propagated through the network and is therefore discarded.

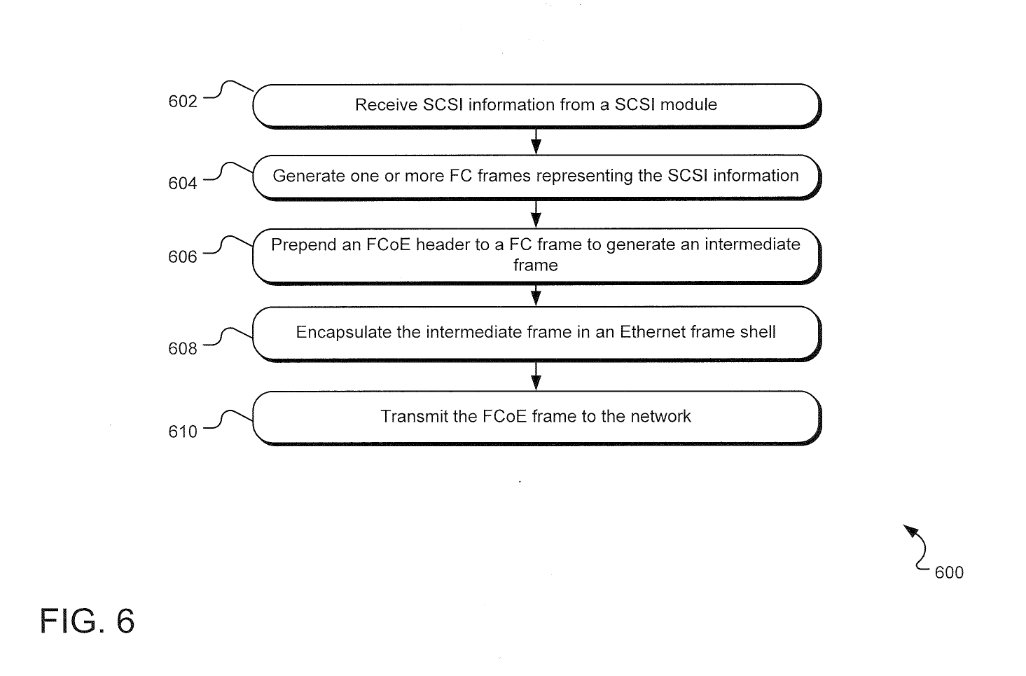

FIG. 6 illustrates example operations 600 for transmitting an FCoE frame down through a communications stack. A receiving operation 602 receives SCSI information from a SCSI module. The SCSI information may conform to a variety of SCSI protocol definitions and may include a variety of possible SCSI commands, responses, and data, including non-data commands, read commands, write commands, and bidirectional commands. The SCSI module interfaces with the file system to obtain access to storage in the device.

A generation operation 604 maps the SCSI information to one or more FC frames, each FC frame including a prepended FC header in accordance with FCP-3. Typically, the FC header is a standard FC header, although variations may be introduced. An addition operation 606 prepends an FCoE header to the FC frame. In different implementations, the FCoE header can include fields such as described with regard to FIGS. 3, 4, and 5. A result of the addition operation 606 is an intermediate frame including an FCoE header, followed by a FC frame that includes a FC header.

An encapsulation operation 608 encapsulates the intermediate frame within an Ethernet frame shell. An example Ethernet frame shell is described with regard to FIGS. 3, 4, and 5. In at least one implementation, the Ethernet frame shell includes an Ethernet preamble field, a destination L2 address field, a source L2 address field and an FCS field. A result of the encapsulation operation 608 is an FCoE frame.

A transmission operation 610 transmits the FCoE frame to the network through an Ethernet PHY interface (e.g., standard Ethernet or DCE).

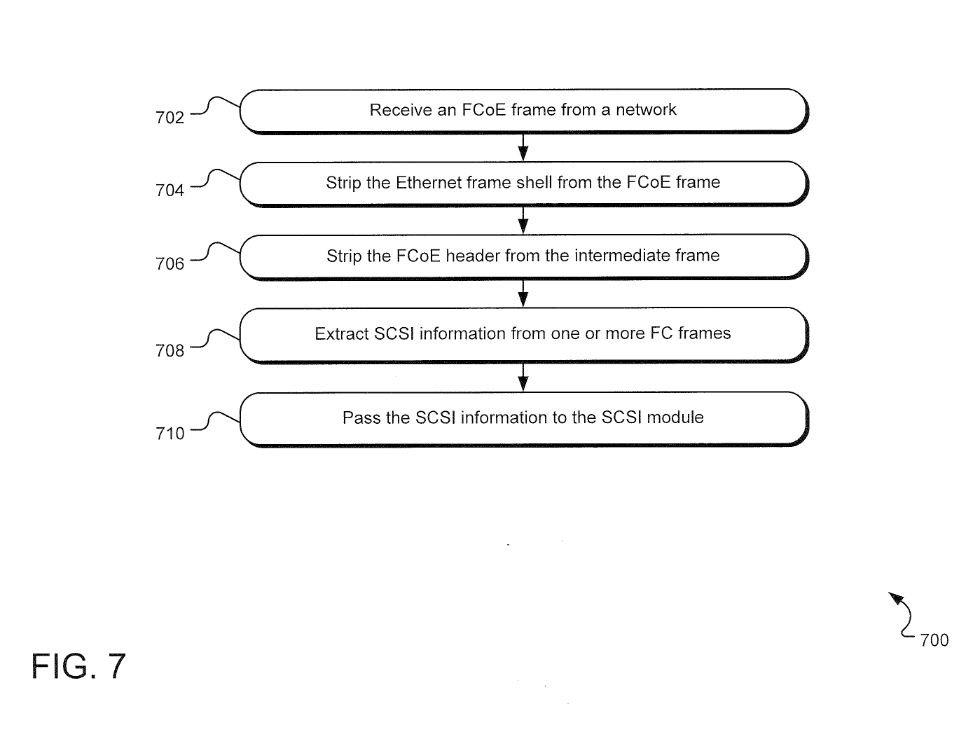

FIG. 7 illustrates example operations 700 for receiving an FCoE frame up through a communications stack. A receiving operation 702 receives the FCoE frame from the network through an Ethernet PHY interface (e.g., standard Ethernet or DCE).

A stripping operation 704 strips an Ethernet frame shell from the FCoE frame to a intermediate frame. An example Ethernet frame shell is described with regard to FIGS. 3, 4, and 5. In at least one implementation, the Ethernet frame shell includes an Ethernet preamble field, a destination L2 address field, a source L2 address field and an FCS field. A result of the stripping operation 704 is an intermediate frame including an FCoE header, followed by a FC frame that includes a FC header.

Another stripping operation 706 strips the FCoE header from the intermediate frame to expose a FC frame. In different implementations, the FCoE header can include fields such as described with regard to FIGS. 3, 4, and 5. An extraction operation 708 strips the FC header from the FC frame and extracts SCSI information from the FC frame as defined in FCP-3. Typically, the FC header is a standard FC header, although variations may be introduced. Other FC frames may also contribute to the SCSI information.

A passing operation 710 passes the SCSI information to a SCSI module. The SCSI information may conform to a variety of SCSI protocol definitions and may include a variety of possible SCSI commands, responses, and data, including non-data commands, read commands, write commands, and bidirectional commands. The SCSI module interfaces with the file system to obtain access to storage in the device.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method of transmitting a Fibre Channel over Ethernet (FCoE) frame to a network, the method comprising:
receiving small computer system interface (SCSI) information from a SCSI module into a communications stack;
mapping the SCSI information to one or more Fibre Channel (FC) frames;
prepending an FCoE header to at least one of the FC frames to form at least one intermediate frame;
encapsulating the intermediate frame in an Ethernet frame shell including a preamble, a destination L2 address, a source L2 address, and a frame checksum to create an FCoE frame;
transmitting the encapsulated FCoE frame from the communications stack to the network.

2. The method of claim 1 wherein the FCoE header further includes a type field including at least one type value specifying a type of the FCoE frame.

3. The method of claim 2 wherein the at least one type value specifies at least one of an FCoE Echo Request, an FCoE Echo Response, an FCoE ARP Request, or an FCoE ARP Response.

4. The method of claim 1 wherein the FCoE header further includes one or more timestamp fields containing one or more timestamp values specifying a synchronized time value for computing network transit times.

5. The method of claim 4 wherein the FCoE header further includes a field containing a data value specifying whether the timestamp values in the timestamp fields are valid.

6. The method of claim 1 wherein the FCoE header further includes a directional field containing a directional value specifying the intended direction of the FCoE frame in the network.

7. The method of claim 6 wherein the directional value specifies that the FCoE frame is intended to travel to an FCoE E_PORT, an FCoE N_PORT, or an FCoE F_PORT.

8. A communication stack system for transmitting a Fibre Channel frame over Ethernet (FCoE) frame to a network, the communications stack system comprising:
a Fibre Channel Protocol (FCP) module coupled to receive small computer system interface (SCSI) information from a SCSI module and configured to map the SCSI information to one or more Fibre Channel (FC) frames;
an FCoE module coupled to receive at least one of the FC frames from the FCP module and configured to prepend an FCoE header to the FC frame to form at least one intermediate frame;
an Ethernet PHY module coupled to receive the intermediate frame and configured to encapsulate the intermediate frame in an Ethernet frame shell including a preamble, a destination L2 address, a source L2 address, and a frame checksum to form an FCoE frame and to transmit the encapsulated FCoE frame to the network.

9. The communications stack system of claim 8 wherein the FCoE header further includes a type field including at least one type value specifying a type of the FCoE frame.

10. The communications stack system of claim 9 wherein the at least one type value specifies at least one of an FCoE Echo Request, an FCoE Echo Response, an FCoE ARP Request, or an FCoE ARP Response.

11. The communications stack system of claim 8 wherein the FCoE header further includes one or more timestamp fields containing one or more timestamp values specifying a synchronized time value for computing network transit times.

12. The communications stack system of claim 11 wherein the FCoE header further includes a field containing a data value specifying whether the timestamp values in the timestamp fields are valid.

13. The communications stack system of claim 8 wherein the FCoE header further includes a directional field containing a directional value specifying the intended direction of the FCoE frame in the network.

14. The communications stack system of claim 13 wherein the directional value specifies that the FCoE frame is intended to an FCoE E_PORT, an FCoE N_PORT, or an FCoE F_PORT.

15. A method of receiving a Fibre Channel over Ethernet (FCoE) frame from a network, the method comprising:
receiving the FCoE frame from the network into a communications stack, wherein the FCoE frame contains a Fibre Channel (FC) frame;
stripping an Ethernet frame shell from the FCoE frame to expose an intermediate frame, wherein the Ethernet frame shell includes a preamble, a destination L2 address, a source L2 address, and a frame checksum;
stripping an FCoE header from the exposed intermediate frame to expose a FC frame;
extracting small computer system interface (SCSI) information from the exposed FC frame;
passing the generated SCSI information in the communication stack to a SCSI module.

16. The method of claim 15 wherein the FCoE header further includes a type field including at least one type value specifying a type of the FCoE frame.

17. The method of claim 16 wherein the at least one type value specifies at least one of an FCoE Echo Request, an FCoE Echo Response, an FCoE ARP Request, or an FCoE ARP Response.

18. The method of claim 15 wherein the FCoE header further includes one or more timestamp fields containing one or more timestamp values specifying a synchronized time value for computing network transit times.

19. The method of claim 18 wherein the FCoE header further includes a field containing a data value specifying whether the timestamp values in the timestamp fields are valid.

20. The method of claim 15 wherein the FCoE header further includes a directional field containing a directional value specifying the intended direction of the FCoE frame in the network.

21. The method of claim 20 wherein the directional value specifies that the FCoE frame is intended to travel to an FCoE E_PORT, an FCoE N_PORT, or an FCoE F_PORT.

22. A communications stack system for receiving a Fibre Channel over Ethernet (FCoE) frame from a network, the communications stack system comprising:
an Ethernet PHY module coupled to receive the FCoE frame from the network, wherein the FCoE frame contains a Fibre Channel (FC) frame, and configured to strip an Ethernet frame shell from the FCoE frame to expose an intermediate frame, wherein the Ethernet frame shell includes a preamble, a destination L2 address, a source L2 address, and a frame checksum;
an FCoE module coupled to receive the intermediate frame from the Ethernet PHY module and configured to strip an FCoE header from the exposed intermediate frame to expose the FC frame;
a FCP module coupled to receive the FC frame from the FCoE module and configured to extract small computer system interface (SCSI) information from the FC frame and to pass the generated SCSI information to a SCSI module.

23. The communications stack system of claim 21 wherein the FCoE header further includes a type field including at least one type value specifying a type of the FCoE frame.

24. The communications stack system of claim 22 wherein the at least one type value specifies at least one of an FCoE Echo Request, an FCoE Echo Response, an FCoE ARP
Request, or an FCoE ARP Response.

25. The communications stack system of claim 21 wherein the FCoE header further includes one or more timestamp fields containing one or more timestamp values specifying a synchronized time value for computing network transit times.

26. The communications stack system of claim 24 wherein the FCoE header further includes a field containing a data value specifying whether the timestamp values in the timestamp fields are valid.

27. The communications stack system of claim 21 wherein the FCoE header further includes a directional field containing a directional value specifying the intended direction of the FCoE frame in the network.

28. The communications stack system of claim 26 wherein the directional value specifies that the FCoE frame is intended to travel to an FCoE E_PORT, an FCoE N_PORT, or an FCoE F_PORT.

29. One or more computer-readable tangible storage media having stored therein a Fibre Channel over Ethernet (FCoE) frame comprising:
a first field containing data representing an Ethernet preamble;
a second field following the first field containing data representing a destination L2 address;
a third field following the second field containing data representing a source L2 address;
a fourth field following the third field containing data specifying either a number of data bytes that are contained in an FCoE data field of the FCoE frame or a frame type ID of the FCoE frame;
a fifth field following the fourth field containing data representing a Fibre Channel over Ethernet (FCoE) header;
a sixth field following the fifth field containing data representing a Fibre Channel (FC) frame;
a seventh field following the sixth field containing data representing a frame checksum for the FCoE frame.

30. The one or more computer-readable tangible media of claim 29 wherein the FCoE header further includes a type field including at least one type value specifying a type of the FCoE frame.

31. The one or more computer-readable tangible media of claim 30 wherein the at least one type value specifies at least one of an FCoE Echo Request, an FCoE Echo Response, an FCoE ARP Request, or an FCoE ARP Response.

32. The one or more computer-readable tangible media of claim 29 wherein the FCoE header further includes one or more timestamp fields containing one or more timestamp values specifying a synchronized time value for computing network transit times.

33. The one or more computer-readable tangible media of claim 32 wherein the FCoE header further includes a field containing a data value specifying whether the timestamp values in the timestamp fields are valid.

34. The one or more computer-readable tangible media of claim 29 wherein the FCoE header further includes a directional field containing a directional value specifying the intended direction of the FCoE frame in the network.

35. The one or more computer-readable tangible media of claim 34 wherein the directional value specifies that the FCoE frame is intended to travel to an FCoE E_PORT, an FCoE N_PORT, or an FCoE F_PORT.
